(19) United States
(12) Patent Application Publication
(10) Pub. No.: US 2002/0105949 A1
(43) Pub. Date: Aug. 8, 2002

(54) Band control device

(76) Inventor: Daisuke Shinomiya, Kawasaki (JP)

Correspondence Address: KATTEN MUCHIN ZAVIS ROSENMAN, 575 MADISON AVENUE, NEW YORK, NY, 10022-2585, US

(21) Appl. No.: 09/904,166

(22) Filed: Jul. 12, 2001

(30) Foreign Application Priority Data
Feb. 6, 2001 (JP) 2001-029638

(51) Int. Cl. H04L 12/66

(52) U.S. Cl. 370/386; 370/389

(57) ABSTRACT

In a band control device having a trunking function used in an end apparatus, a relaying apparatus, and the like, a distributor distributes a traffic to a sub-logical link into which specified ones of the physical links in the logical link are aggregated so as to meet a specified condition of the traffic. Also, the physical links of a number corresponding to the traffic amount is assigned to the sub-logical link. A controller transmits/receives a message for establishing the sub-logical link to/from an opposite controller, and further relays the message to the subsequent apparatus.

### BACKGROUND OF THE INVENTION

1. Field of the Invention

The present invention relates to a band control device, and in particular to a frequency bandwidth control device having a trunking or aggregating function used for an end apparatus (system), a relaying apparatus, and the like.

Recently, an intranet has rapidly spread over a number of enterprises along with the function and performance of a personal computer and a network being enhanced and their prices being lowered. The intranet is an enterprise IP (Internet Protocol) network incorporating the function, the technology, and the like used in the Internet. Its communication protocol is highly occupied with the IP, which tendency becomes further intensive.

The intranet uses not only an e-mail and WWW (World Wide Web) but also business data and multimedia data such as streaming of animation and the like. For the transmission of such various data, a high speed performance and a reliability have become important.

Also, Ethernet standardized by the IEEE which plans a standard of an LAN/MAN is widely spread as an IP protocol of a lower layer in the intranet.

The Ethernet has been short of a bandwidth between a server and a switch, in a backbone, or the like with the recent increase of an end user's traffic amount, so that Gigabit Ethernet solving the shortage of the bandwidth has been spreading.

2. Description of the Related Art

As a technology for realizing the above mentioned high speed (wide band) function and reliability of the network, there is a technology called trunking. This technology is a generic name of a technology aggregating a plurality of physical links into a single logical link, such as a link aggregation technology standardized by the IEEE802.3ad or a vendor-specific technology, having an equivalent function to the link aggregation technology. Hereinafter, such a trunking technology will be occasionally referred to as a link aggregation.

One example of a prior art link aggregation will be described based on FIGS. 13A and 13B.

In FIG. 13A, relaying apparatuses 2_1 and 2_2 (sometimes generally represented by reference numeral 2) respectively accommodate end apparatuses (systems) 1_1-1_4 and 1_5-1_8 (sometimes generally represented by reference numeral 1). The relaying apparatuses 2_1 and 2_2 are mutually connected with four 100 Mbps-physical links 80_1-80_4 (sometimes generally represented by reference numeral 80).

The link aggregation is a technology for aggregating, for example, the physical links 80_1-80_4 into a pseudo single logical link 81, thereby enabling the band of the logical link 81 to be widened to 100 Mbps×4=400 Mbps.

Also, in case of a failure occurring in the physical link 80_1 for example, the link aggregation enables continued communication using the remaining physical links 80_2-80_4, so that the reliability can be secured by redundancy.

It is to be noted that while the link aggregation of the physical links 80_1-80_4 between the relaying apparatuses 2_1 and 2_2 is described in FIG. 13A, the link aggregation can be similarly performed in case where the end apparatus 1 and the relaying apparatus 2 are mutually connected with a plurality of physical links or the end apparatuses 1 are mutually connected with a plurality of physical links.

The function by which link aggregation groups are provided between two end apparatuses 1, between two relaying apparatuses 2, or between the end apparatus 1 and the relaying apparatus 2 will be described referring to FIG. 13B by taking the case of two relaying apparatuses 2 as an example.

System ID's=“A” and “B” are respectively set for the relaying apparatuses 2_1 and 2_2. The physical links 80_1-80_4 between the two relaying apparatuses 2_1 and 2_2 can perform the link aggregation in case link aggregation group identifiers (hereinafter, abbreviated as LAGID) of ports 10_1-10_4 (hereinafter sometimes generally represented by reference numeral 10) respectively accommodating the physical links 80 are the same.

The LAGID assumes, for example, a value (A+L1, B+L1) obtained by combining the system ID=“A” or “B” of the apparatus itself with a key value=“L1” identifying the link aggregation group on the same apparatus where a plurality of groups may exist on the same apparatus.

By the composition of the LAGID value, band control devices of the relaying apparatuses 2_1 and 2_2 can recognize a partnership with the link aggregation group of the connection destination, and can effectively connect only the groups having the same LAGID value.

The system ID and the key value which form the basis of the LAGID value are mutually exchanged by an LACPDU (Link Aggregation Control Protocol Data Unit) frame which dynamically exchanges information between the relaying apparatuses 2_1 and 2_2.

As for the relationship between the relaying apparatuses 2_1 and 2_2, one of them is an actor which firstly transmits the LACPDU frame and the other is a partner which receives the LACPDU frame from the actor, so that they mutually exchange the information.

FIGS. 14A and 14B show an arrangement of the end apparatuses 1_1 and 1_5, and the relaying apparatuses 2_1 and 2_2 shown in FIG. 13A. In the end apparatuses 1_1 and 1_5, the port 10 connected to the relaying apparatus 2 with a physical link 80a, a band control device 100, and an MAC client 50 are connected in cascade.

In the relaying apparatuses 2_1 and 2_2, a port 10a connected to the physical link 80a, a band control device 100a, and the MAC client 50 are connected in cascade, and a port 10b connected to the partner relaying apparatus 2 with a physical link 80b, and a band control device 100b are further connected to the MAC client 50 in cascade.

It is to be noted that the physical link 80b and the port 10b in FIG. 14A generally include the physical links 80_1-80_4 and the ports 10_1-10_4 in FIG. 13B, respectively.

FIG. 14B shows more in detail the connection between the port 10, the band control device 100, and the MAC client 50 composing the end apparatus 1 or the relaying apparatus 2.

The band control device 100 is composed of a distributor 20 for transferring a frame 83 received from the MAC client 50 to an adequate port selected from among the ports 10_1-10_4, a collector 30 for providing a frame 97 received by the ports 10_1-10_4 to the MAC client 50 of the upper layer through the collector 30, and an aggregation controller 40.

The port 10 receives a frame from an opposite apparatus, and determines whether or not it is a controlling frame (LACPDU). In case of the LACPDU, the frame is transmitted to the aggregation controller 40, while in case of a communicating frame other than the frame, the frame is transmitted to the collector 30.

Also, the port 10 transmits the communicating frame and the LACPDU respectively received from the distributor 20 and the aggregation controller 40 to the opposite apparatus.

The aggregation controller 40 controls and manages the distributor 20 and the collector 30, transmits/receives the LACPDU frame through the port 10, and manages a new preparation, a deletion and the like of the link aggregation group.

The format of the LACPDU frame will be described based on FIG. 15.

The LACPDU frame is basically an MAC frame, and has an MAC header composed of destination address, source address, length/type, subtype=“LACP”, and version number at the top, and a frame check sequence (FCS) at the bottom. In the subtype, “LACP” is set indicating the frame based on the Link Aggregation Control Protocol.

Furthermore, the LACPDU frame has a TLV (Type, Length, Value) information indicating actor information, partner information, max delay time information, terminating information, and the like between the MAC header and the FCS. The actor information is composed of TLV type=“actor information”, actor information length=“20”, actor system priority, actor system, actor key, actor port priority, actor port, actor state, and reserved. The partner information is composed of information relating to the partner similar to the actor information.

The max delay time information is composed of TLV type=“collector information”, collector information length =“16”, collector max delay, and reserved. The terminating information is composed of TLV type=“terminator”, and terminator length=“0”.

As shown in FIG. 13B, the aggregation controller 40 in the end apparatus 1 or the relaying apparatus 2 determines the link aggregation group by exchanging the LACPDU frames.

As specific prior art systems for realizing the link aggregation technology, the following three can be mentioned:

(1) System in which a traffic between a specified transmission terminal and a receiving terminal always uses the same physical link 80:

(2) System in which the physical link 80 to be used is selected by e.g. a round robin method according to the available states (e.g. available rates) of the physical link 80:

(3) System in which the same traffic averagely uses all of the physical links 80 within the link aggregation in parallel.

In the prior art system (1), there is a possibility that the available states of the physical links 80 are unbalanced, and that the traffic concentrates on a single physical link 80, and a frame is abandoned although the other physical links 80 are empty. Also, the maximum band is limited to a band for a single physical link for a traffic satisfying a specified condition.

Also in the system (2), the problem of the system (1) that the traffic concentrates on a single physical link 80 is solved by equally assigning the available rates of the physical links. However, the problem that the maximum band is limited to a band for a single physical link is not solved.

Also in the system (3), the problems of the systems (1) and (2) are solved. However, in case other traffics are large for example, it is impossible to guarantee the band only for the traffic satisfying the specified condition, and to establish two or more physical links exclusively used for the traffic satisfying the specified condition.

### SUMMARY OF THE INVENTION

It is accordingly an object of the present invention to guarantee a band by assigning a physical link exclusively to a specified traffic, and to perform a band control of the traffic, in a band control device for aggregating a plurality of physical links into a single logical link.

In order to achieve the above-mentioned object, a band control device of the present invention according to claim 1 comprises: a controller for aggregating a plurality of physical links into a single logical link, and a distributor for distributing a traffic to a sub-logical link into which specified ones of the physical links in the logical link are aggregated so as to meet a specified condition of the traffic.

FIGS. 1A and 1B show general network examples in which a band control device according to the present invention is used. In the network shown in FIG. 1A, a relaying apparatus 2_1 accommodating end apparatuses 1_1-1_4 is connected to a relaying apparatus 2_2 accommodating end apparatuses 1_5-1_8 with physical links 80_9-80_13.

The end apparatuses 1_1-1_4 are respectively connected to the relaying apparatus 2_1 with physical links 80_1-80_4, 80_5, 80_6, and 80_7 and 80_8. The end apparatuses 1_5-1_8 are similarly connected to the relaying apparatus 2_2 with the physical links 80.

In the network shown in FIG. 1B, the relaying apparatuses 2_1 and 2_2 respectively accommodating the end apparatuses 1_1 and 1_2 are connected with a single physical link of 1 Gbps. The band control device according to the present invention can be used even in case where the apparatuses are not connected with a plurality of physical links.

FIG. 1C schematically shows a band control device according to the present invention, in which a controller of the band control device (not shown) included in e.g. the end apparatus 1 or the relaying apparatus 2 has a prior art trunking function of aggregating a plurality of physical links 80 into a single logical link 81.

In FIG. 1C, the band control device of the end apparatus 1, and the band control device of the relaying apparatus 2 opposite to that of the end apparatus 1, for example, can respectively aggregate the physical links 80_1-80_4 into a single logical link 81_1, and the band control device of the relaying apparatus 2 can further aggregate the physical links 80_9-80_13 into a single logical link 81_3.

In addition to such a prior art trunking function, a distributor of the band control device according to the present invention can aggregate the physical links 80_1 and 80_2, into a sub-logical link 82_1, within the physical links 80_1-80_4 aggregated into the logical link 81_1, for example, to be treated as a single link, and can assign (hereinafter, occasionally referred to as occupy) the sub-logical link 82_1 exclusively to a traffic (hereinafter, occasionally referred to as object traffic) which meets a specified condition.

Similarly, the distributor of the band control device in the relaying apparatus 2 can assign a single sub-logical link 82_3 into which the physical links 80_9 and 80_10 within the physical links 80_9-80_13 are aggregated exclusively to a traffic which meets a specified condition, and further can assign a sub-logical link 82_4 for only the physical link 80_11 exclusively to a traffic which meets another specified condition.

Thus, the band control device can guarantee the band for the traffic which meets the specified condition.

Also, in the present invention of claim 2, the distributor may comprise a traffic monitor for monitoring a traffic amount which meets the specified condition, and a manager for assigning the physical links of a number corresponding to the traffic amount to the sub-logical link.

Namely, the distributor has a traffic monitor, for monitoring a traffic amount which meets the specified condition, which provides the traffic amount to a manager. When the traffic amount which meets the specified condition assigned to the sub-logical link 81_1 increases for example, the manager assigns three physical links 80_1-80_3 to the sub-logical link 82_1. Conversely when the traffic amount decreases, the manager makes only the physical link 80_1 the sub-logical link 82_1.

Thus, it becomes possible for the band control device to dynamically change the band of the sub-logical link according to the traffic amount which meets the specified condition, and to reduce a redundant band for a traffic 83_1. Namely, it becomes possible to perform a band variable control of the sub-logical link assigned to the traffic which meets the specified condition.

Also, in the present invention of claim 3, when detecting that the traffic amount becomes smaller than a predetermined value during a predetermined period, the traffic monitor may release an aggregation of the sub-logical link to assign no sub-logical link exclusively used for the traffic which meets the specified condition.

Thus, exclusive-use-sub-logical links do not have to be assigned to the traffic which meets the specified condition, than needed.

It is to be noted that the band control device of the opposite apparatus which receives an object traffic 83a and a non-object traffic 83b may receive the traffic without being conscious that the traffic is either the object traffic 83a or the non-object traffic 83b, and may transmit the traffic to the upper MAC client 50 for example.

Accordingly, providing at least the apparatus on the transmitting side with the band control device according to the present invention makes it possible to increase/decrease the number of the physical links in the sub-logical link 82 exclusively used for the object traffic 83, or release the occupation (exclusive use) according to the traffic amount of the object traffic 83 between two end apparatuses 1, between the end apparatus 1 and the relaying apparatus 2, and between two relaying apparatuses 2.

FIG. 1D shows a case where the sub-logical links 82_1, 82_2, 82_3 and 82_4, 82_5, and 82_6 are respectively established in the logical links 81_1, 81_2, 81_3, 81_4, and 81_5 established in the network shown in FIG. 1A.

The sub-logical links 82_1, 82_3, and 82_5 are assigned exclusively to the object traffic 83_1, and the sub-logical links 82_2, 82_4, and 82_6 are assigned exclusively to an object traffic 83_2.

Thus, in order to assign the sub-logical links exclusively to the object traffic 83_1, the sub-logical links 82_1, 82_3, and 82_5 must be commonly established so as to guarantee the band of the object traffic 83_1 respectively between the end apparatus 1_1—the relaying apparatus 2_1, the relaying apparatuses 2_1—2_2, and the relaying apparatus 2_2—the end apparatus 1_5.

Therefore, in the band control device of the present invention according to claim 4, the controller may transmit/receive a message for establishing the sub-logical link to/from an opposite controller.

Namely, in the network system arrangement of FIG. 1D, the controller (not shown) of the end apparatus 1_1 and the relaying apparatus 2_1, for example, can transmit/receive (signal) a message for establishing the sub-logical link 82_1 common to both apparatuses.

Also, in the present invention of claim 5, the controller may relay the message to a subsequent apparatus.

Namely, the relaying apparatus 2_1, for example, can relay the message received from the end apparatus 1_1 to the subsequent relaying apparatus 2_2.

Thus, it becomes possible to establish the sub-logical link for the traffic which meets the specified condition between the source end apparatus 1_1 and the destination end apparatus 1_5.

Furthermore, the distributor can make the number of the physical links aggregated into the sub-logical link less than the number of the physical links aggregated into the logical link, whereby the band of the sub-logical link exclusively used for the traffic which meets the specified condition may occupy the band of the entire logical link.

In the present invention of claim 6, when a failure occurs in the physical link not aggregated into the sub-logical link for example, the state can be avoided where a traffic except the traffic which meets a specified condition can not be communicated.

Also, in the present invention of claim 7, the controller may return a message for establishing a sub-logical link port having been established based on the received message as a return sub-logical link port, whereby a bidirectional sub-logical link may be established in order to guarantee the band of the traffic which meets the specified condition.

Also, in the present invention of claim 8, the controller may return a response message for the received message, whereby the communication whose band is guaranteed may be reliably achieved between the end apparatuses.

Also, in the present invention of claim 9, the controller may return, in response to the message requesting the establishment of the sub-logical link, a message rejecting the request.

Also, in the present invention of claim 10, when receiving the response message, the controller may commence a communication of the traffic which meets the specified condition, whereby the communication may be reliably commenced.

Also, in the present invention of claim 11, when a band of the sub-logical link requested by the received message is larger than an assignable band of a sub-logical link in the subsequent apparatus, the controller may discard the message and may return an error message, whereby the occurrence of the sub-logical link which becomes a bottleneck on a route may be avoided.

Also, in the present invention of claim 12, a scheduler for transmitting a traffic, with a priority control, to the subsequent apparatus may be provided, and the controller may instruct the scheduler to transmit the traffic which meets the specified condition with a priority, and transmit a message notifying a request band of the traffic to the subsequent apparatus, whereby the band of the traffic which meets the specified condition in the link may be guaranteed by the scheduler when a single link having a large band on the route exits for example.

Also, in the present invention of claim 13, when a communication of the traffic which meets the specified condition is completed, the controller may transmit a message requesting an establishment release of the sub-logical link corresponding to the traffic, thereby preventing the traffic which meets the specified condition from occupying the band more than needed.

Also, in the present invention of claim 14, when receiving the message requesting the establishment release, the controller may relay the establishment release request message to a subsequent apparatus.

Also, in the present invention of claim 15, a traffic monitor for monitoring a traffic amount which meets the specified condition may be further provided, and the controller may release the establishment of the sub-logical link when the traffic amount becomes smaller than a predetermined amount. It is to be noted that the traffic monitor of claim 2 may be used as the traffic monitor.

Also, in the present invention of claim 16, when the physical link included in the sub-logical link degenerates and no physical link substituted for the degenerated physical link can be secured, the controller may transmit a message requesting that a number of physical links included in the sub-logical link should be decreased, whereby the case where the physical link occupied by the sub-logical link degenerates by a failure on a route or the like, for example, may be attended.

Also, in the present invention of claim 17, when no physical link exists since the physical link excluded in the sub-logical link is degenerated, the controller may transmit a message requesting that a number of physical links included in the sub-logical link should be decreased, whereby the state may be avoided where the traffic except the traffic which meets a specified condition can not communicate.

Also, in the present invention of claims 18-20, a traffic monitor for monitoring an amount of a traffic except the traffic which meets the specified condition may be further provided, and the controller may decrease a number of physical links included in the sub-logical link when the traffic amount becomes larger than a predetermined amount, and may output a message requesting that the number should be decreased. When receiving the number decrease request message, the controller may relay the message to a subsequent apparatus when it exists, and may decrease the number of physical links included in a corresponding sub-logical link when the apparatus does not exist, whereby the case where the traffic except the traffic which meets the specified condition increases may be attended.

Also, in the present invention of claim 21, when receiving a message requesting an establishment of a sub-logical link different from the sub-logical link already established and no requested band can be secured, the controller may return an error message, thereby preventing the physical link included in the sub-logical link already established from being overlapped with another sub-logical link.

Furthermore, in the present invention of claim 22, when receiving the error message, a source controller of the establishment request message may transmit again the establishment request message after a standby for a fixed period.

Also, in the present invention of claim 23, when a plurality of sub-logical links are established in the single logical link, the controller may determine a sub-logical link for decreasing a number of physical links by a priority of the sub-logical link.

Also, in the present invention of claim 24, the traffic from an opposite apparatus may be received by a collector.

### BRIEF DESCRIPTION OF THE DRAWINGS

FIGS. 1A-1D are block diagrams showing a network system arrangement in which a band control device according to the present invention is used;

FIG. 2 is a block diagram showing an embodiment of an extended distributor in a band control device according to the present invention;

FIGS. 3A-3C are diagrams showing examples of an identifying data table used in a band control device according to the present invention;

FIG. 4 is a block diagram showing an embodiment of a manager in a band control device according to the present invention;

FIGS. 5A-5C are diagrams showing table examples included in a manager in a band control device according to the present invention;

FIG. 6 is a flow chart showing an operation of a manager in a band control device according to the present invention;

FIG. 7 is a block diagram showing an embodiment of an extended aggregation controller in a band control device according to the present invention;

FIG. 8 is a diagram showing an example of a shared information table used in an extended aggregation controller in a band control device according to the present invention;

FIG. 9 is a diagram showing an arrangement of an extended message used in a band control device according to the present invention;

FIGS. 10A and 10B are sequence diagrams showing examples of operation procedures in a network composed of end apparatuses and relaying apparatuses using the band control device according to the present invention;

FIG. 11 is a block diagram showing an example of a priority control in case where a single physical link having a wide band exists in a network using a band control device according to the present invention;

FIG. 12 is a block diagram showing a function in case where a single physical link having a wide band exists in a network using a band control device according to the present invention;

FIGS. 13A and 13B are block diagrams showing an outline of a prior art link aggregation;

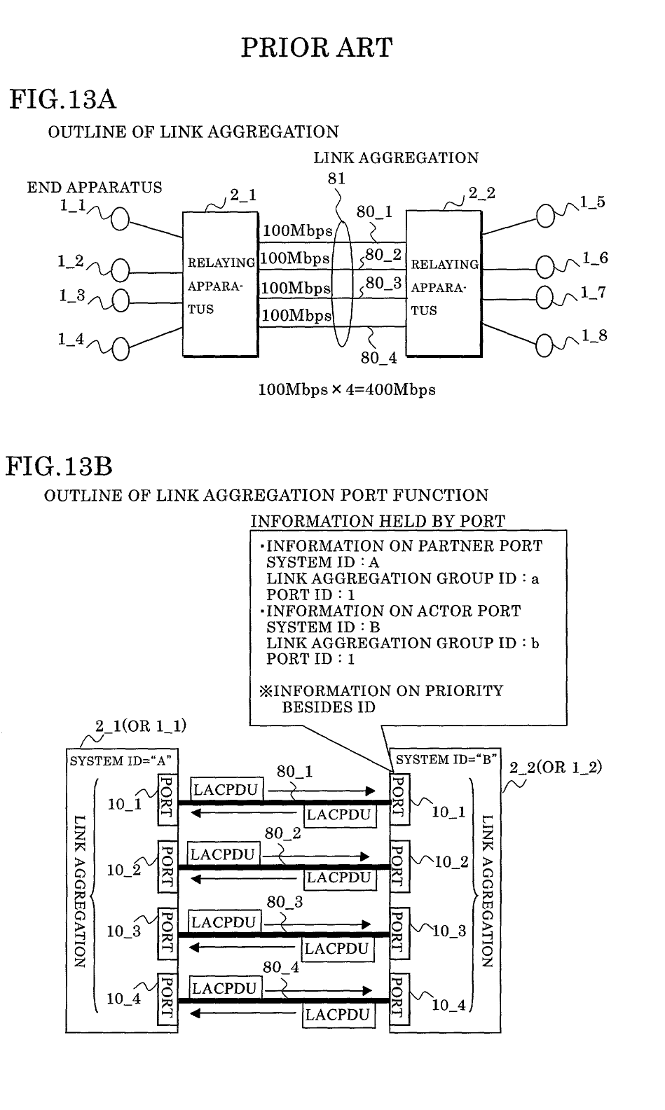

FIGS. 14A and 14B are block diagrams showing an arrangement of a general band control device and a network example composed of end apparatuses and relaying apparatuses using the general band control device; and

FIG. 15 is a diagram showing an arrangement of an LACPDU frame used in the prior art link aggregation.

Throughout the figures, like reference numerals indicate like or corresponding components.

### DESCRIPTION OF THE EMBODIMENTS

Embodiment (1)

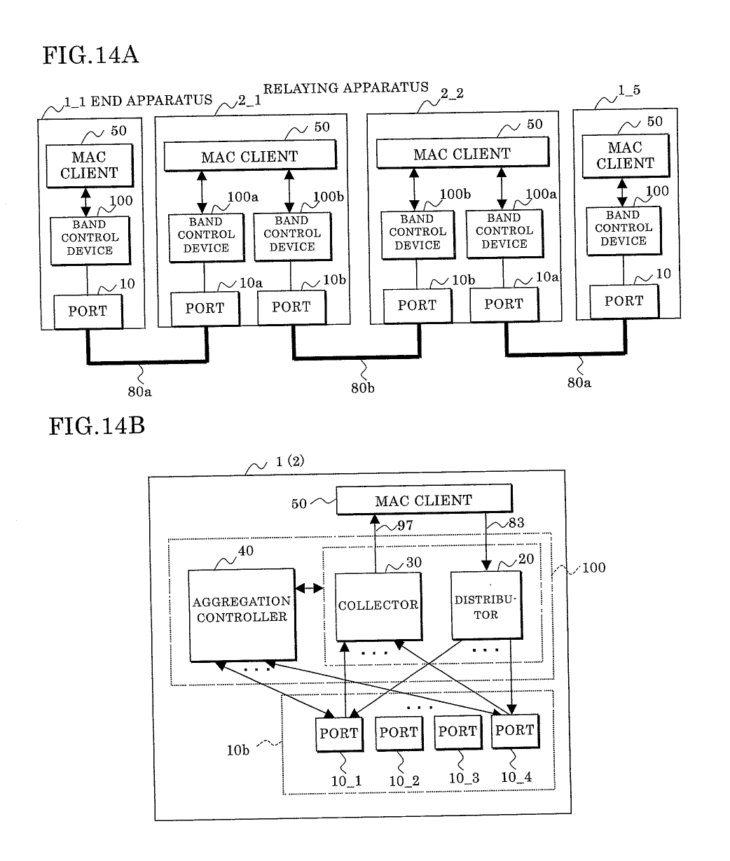

A basic arrangement of a band control device 100 according to the present invention is the same as that of the band control device 100 shown in FIG. 14B, which is composed of a distributor 20, a collector 30, and an aggregation controller 40

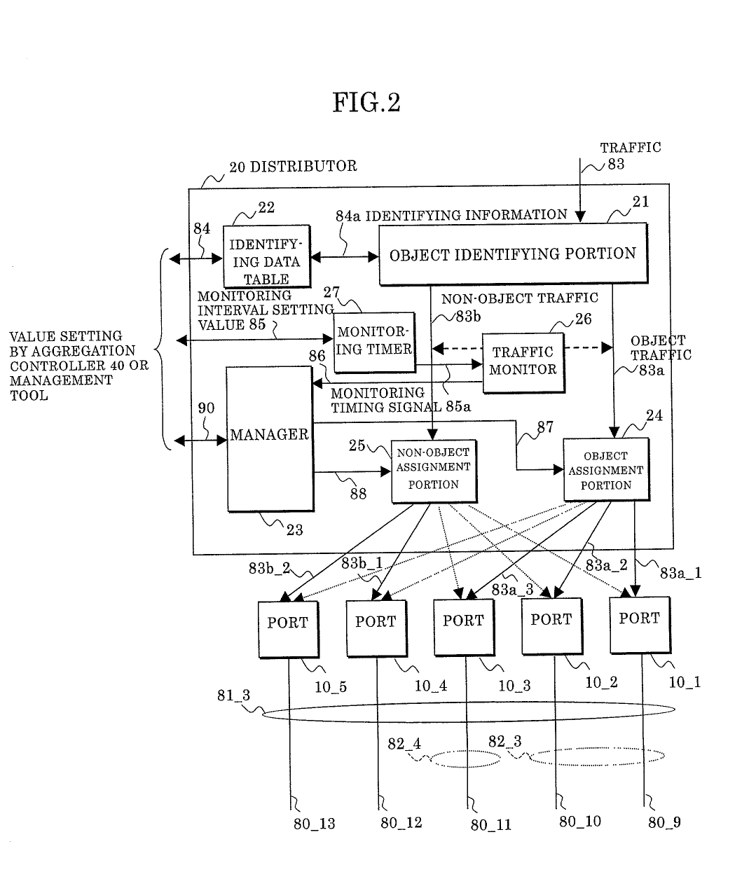

FIG. 2 shows an embodiment of the distributor 20 according to the present invention in which the prior art distributor 20 is extended.

The distributor 20 includes an identifying data table 22 prepared based on identifying information 84 from the aggregation controller 40 (see FIG. 14B) or a management tool (not shown) (hereinafter sometimes both are commonly referred to as controller 40), an object identifying portion 21 for identifying the object traffic 83a which meets a specified condition and the non-object traffic 83b which does not meet the specified condition based on identifying data 84a of the table 22 in a traffic 83 received from a MAC client 50 (see FIG. 14B), an object assignment portion 24 for assigning the received object traffic 83a to ports 10_1-10_3 connected to sub-logical links 82_3 and 82_4, and a non-object assignment portion 25 for assigning the received non-object traffic 83b to other ports 10_4 and 10_5.

In addition, the distributor 20 includes a manager 23 for managing the object assignment portion 24 and the non-object assignment portion 25 by update information 87 and 88 based on a signal 90 from the controller 40, a traffic monitor 26 for monitoring the object traffic 83a and the non-object traffic 83b to transmit traffic amount information 86 to the manager 23, and a monitoring timer 27 for providing a motoring timing signal 85a to the monitor 26 based on a monitoring interval setting value 85 from the controller 40.

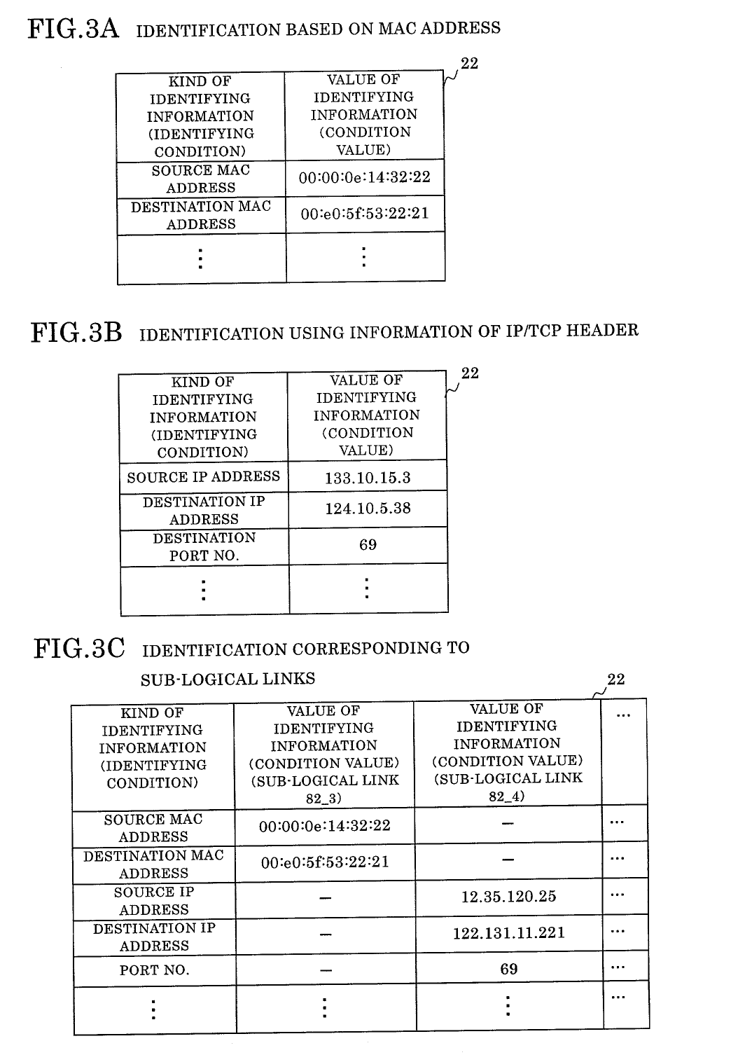

FIGS. 3A-3C show embodiments of the identifying data tables 22. The tables 22 are the identifying information 84 which indicates the conditions for identifying the object traffic 83a, and there are various identification methods.

For example, in the table 22 shown in FIG. 3A, the traffic 83 having source MAC address=“00:00:0e:14:32:22” and destination MAC address=“00:e0:5f:53:22:21” is established to be the object traffic 83a.

Namely, the traffic 83 transmitted from the end apparatus having the MAC address=“00:00:0e:14:32:22” to the end apparatus having the MAC address=“00:e0:5f 53:22:21” is selected as the object traffic 83a, which is transmitted through one of e.g. ports 10_1-10_(N-1) corresponding to the sub-logical link.

Also, it is possible to set upper layer data such as a source/destination port No. of TCP header, a source/destination IP address of IP header, and a Type Of Service (TOS) field in the table 22.

In the table 22 of FIG. 3B, the traffic 83 addressed to the end apparatus having the destination port No.=“69” and the IP address=“124.10.5.38” from the end apparatus having the IP address=“133.10.15.3” is established as the object traffic 83a.

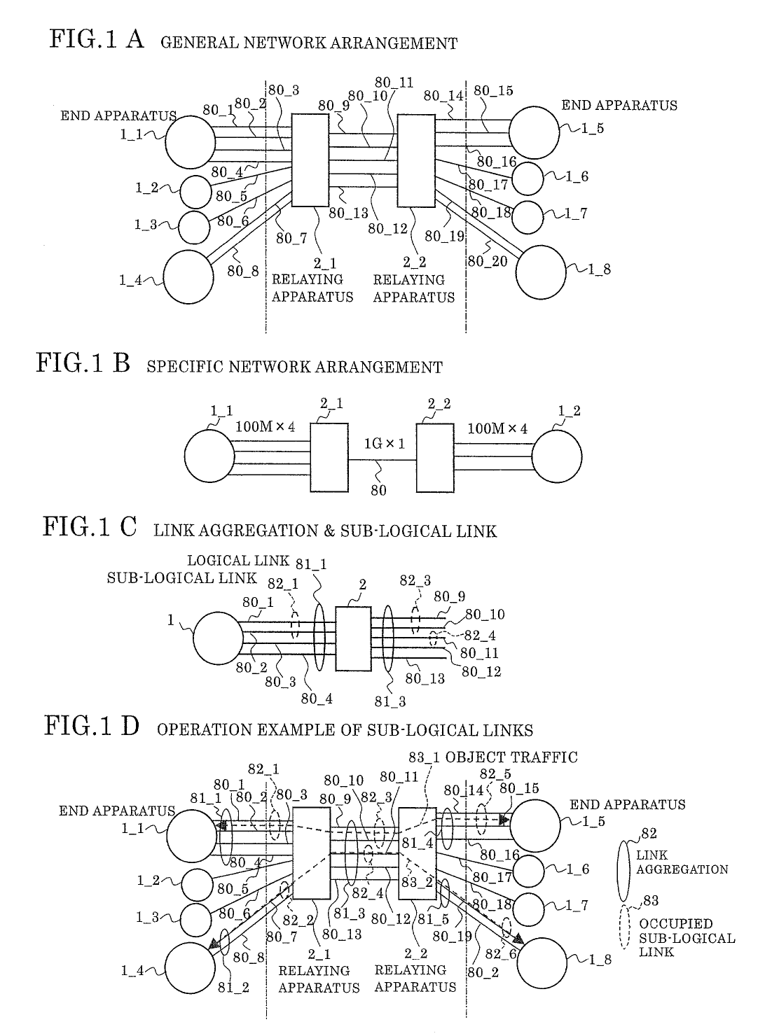

Furthermore, it is also possible to establish a plurality of sub-logical links 82_3 and 82_4 e.g. in a single logical link 81_1 as shown in FIG. 1C.

FIG. 3C shows an embodiment of the table 22 corresponding to the sub-logical links 82_3 and 82_4. The conditions for identifying the object traffic 83a which occupies the sub-logical link 82_3 are the same as that of FIG. 3A, and the conditions for identifying the object traffic 83a which occupies the sub-logical link 82_4 are the source IP address=“12.35.120.25”, the destination IP address=“122.131.11.221” and the port No.=“69”.

\mathring{1}: Occupation by Sub-logical Link

In FIG. 2, the object traffic 83a and non-object traffic 83b thus identified are respectively transmitted to the object assignment portion 24 and the non-object assignment portion 25.

The object assignment portion 24 transmits the object traffic 83a to one of the ports 10_1-10_3 to which the sub-logical links 82_3 and 82_4 assigned by the manager 23 are connected, while the non-object assignment portion 25 transmits the non-object traffic 83b to either of the port 10_4 or 10_5 assigned by the manager 23.

It is to be noted that the port corresponding to the sub-logical link is notified to the manager 23 from the controller 40, so that this notification enables the object traffic 83a and the non-object traffic 83b to be transmitted to the half fixedly assigned ports.

Also, it is possible for the manager 23 not only to transmit the object traffic 83a and the non-object traffic 83b to the half fixedly assigned ports, but also to dynamically change the number of the physical links (number of ports) aggregated into the sub-logical link corresponding to the change of the traffic amount.

Furthermore, it is also possible for the manager 23 to release the sub-logical link in case the traffic amount of the object traffic 83a is too small to occupy a single physical link.

\mathring{2}: Dynamic Change of Physical Link Number

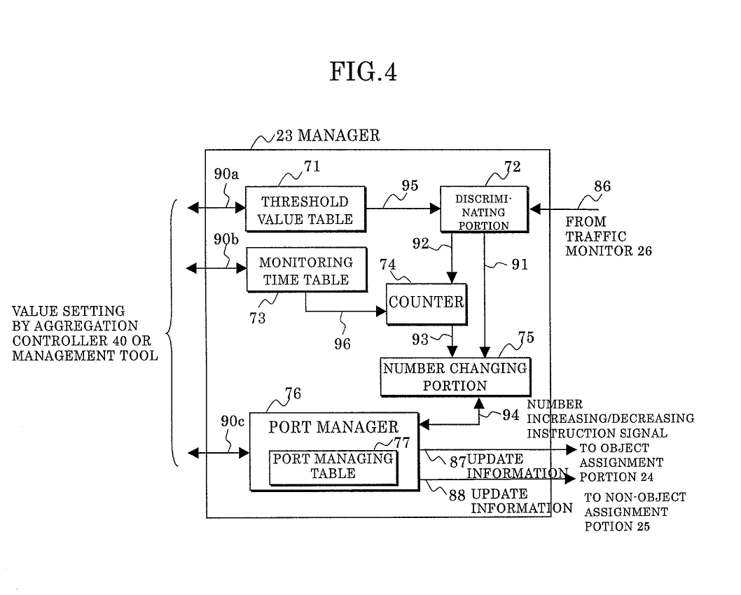

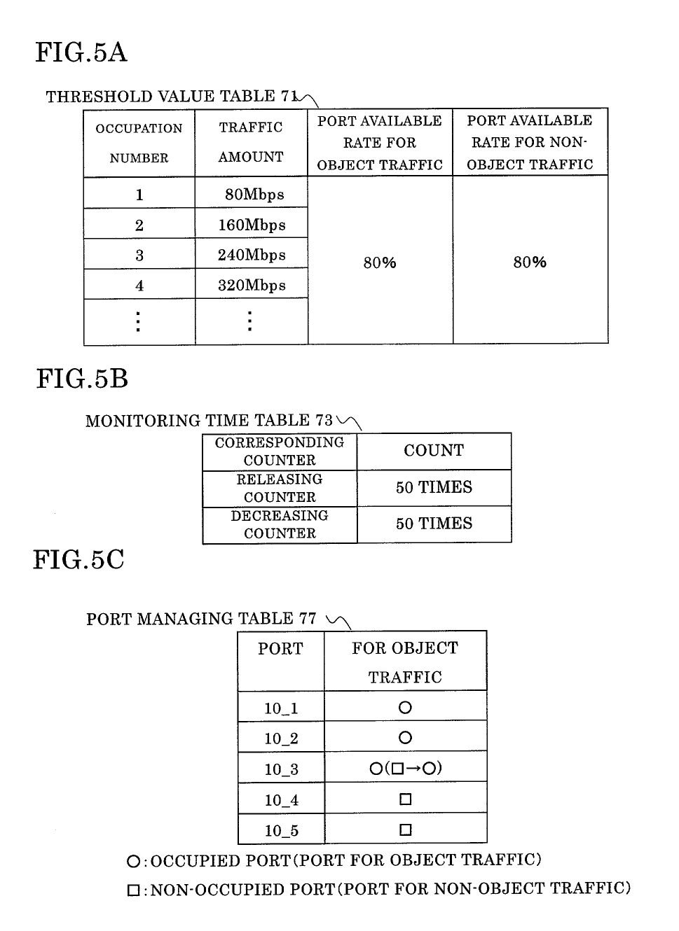

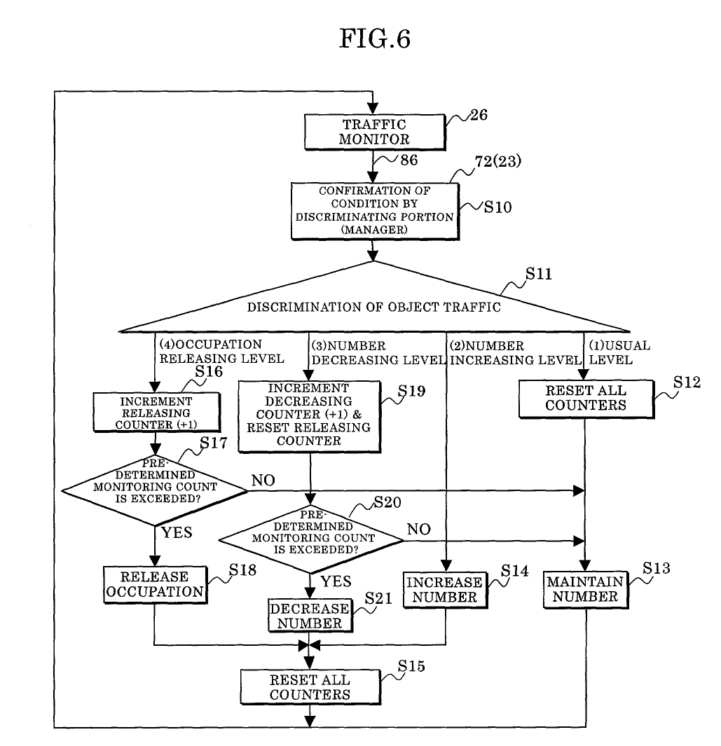

Hereinafter, the operation procedures of changing the number of the physical links (ports) assigned to the sub-logical links corresponding to the change of the traffic amount, and of releasing the sub-logical link will be described referring to FIG. 6, after firstly describing the outline arrangement of the manager 23 in FIGS. 4 and 5A-5C.

FIG. 4 shows an embodiment of the manager 23, which is composed of a threshold value table 71, a discriminating portion 72, a monitoring time table 73, a counter 74, a number changing portion 75, and a port manager 76.

Also, the port manager 76 includes a port managing table 77, and the counter 74 includes a decreasing counter and a releasing counter (both are not shown). The decreasing counter serves to discriminate whether or not the number of the ports should be decreased, and counts “frequency” in case where the traffic amount of the object traffic 83a is equal to or less than “a predetermined threshold value”.

The releasing counter serves to discriminate whether or not the establishment of the sub-logical link 82_3 should be released in case the traffic amount of the object traffic 83a is too small to occupy a single physical link, and counts the “frequency” in case where the traffic amount of the object traffic 83a is equal to or less than “a predetermined threshold value”.

FIGS. 5A-5C respectively show a threshold value table 71, a monitoring table 73, and a port managing table 77. The setting values of the tables 71, 73, and 77 are provided by the controller 40.

In the table 71 of FIG. 5A, as the above-mentioned “predetermined threshold value”, “traffic amount”=80 Mbps, 160 Mbps, 240 Mbps, and 320 Mbps . . . , “port available rate for object traffic”=80%, and “port available rate for non-object traffic”=80%, are set corresponding to “port number”=1, 2, 3, 4, . . . occupied by the object traffic 83a or the non-object traffic 83b.

In the table 73 of FIG. 5B, as the above-mentioned “frequency”, the frequency=“50” is set for a threshold value of the releasing counter and the decreasing counter.

In the table 77 of FIG. 5C, it is shown whether each of the ports 10_1-10_5 is the port for the object traffic or the non-object traffic. Namely, it is shown that the ports 10_1 and 10_2 are “∘: port for the object traffic”, and the ports 10_3-10_5 are ″□: port for the non-object traffic.

FIG. 6 shows operation procedure examples of changing the number of the physical links and of releasing the sub-logical link. Hereinafter, the operation of changing the number (two of physical links 80_9 and 80_10 at present) of the physical links 80 included in the sub-logical link 82_3 shown in FIG. 2 and the releasing operation of the sub-logical link 82_3 will be described.

Although the sub-logical link 82_4 is also established in the logical link 81_3 in FIG. 2 at present, the sub-logical link 82_4 is supposed not to be established. Accordingly, the port 10_3 (physical link 80_11) is a port for a non-object traffic, “∘” is set in the ports 10_1 and 10_2, and “□” is set in the ports 10_3-10_5 of the table 77 in FIG. 5B.

In FIG. 2, the traffic monitor 26 monitors the traffic amount of the object traffic 83a and the non-object traffic 83b per unit time based on the monitoring timing signal 85a notified from the monitoring timer 27 at the fixed time intervals, so that the traffic amount information 86 is notified to the manager 23.

Step S10 in FIG. 6: The discriminating portion 72 (see FIG. 4) of the manager 23 receives the present traffic amount information 86.

Step S11: The discriminating portion 72 compares the information 86 with the threshold value table 71.

(1) In case the information 86 is the traffic amount of the object traffic 83a=100 Mbps for example, the discriminating portion 72 calculates as follows: Since the number of the physical links occupied at present is two, 160 Mbps (traffic amount in case of two physical links)×80% (available rate)=128 Mbps, and 80 Mbps (traffic amount in case of one physical link)×80%=64 Mbps are calculated from the threshold value table 71. Then, the discriminating portion 72 discriminates that the present traffic amount=100 Mbps is between the both traffic amounts, i.e. 128 Mbps and 64 Mbps, so that “regular level” not requiring the change of the number of the physical links is discriminated.

(2) In case of the traffic amount of the object traffic 83a=150 Mbps for example, the discriminating portion 72 discriminates it to be “number increasing level” since the traffic amount=150 Mbps exceeds 160 Mbps (traffic amount for two physical links)×80% (available rate)=128 Mbps.

(3) In case of the traffic amount of the object traffic 83a=50 Mbps for example, the discriminating portion 72 discriminates it to be “number decreasing level” since the traffic amount=50 Mbps is equal to or less than 80 Mbps (traffic amount for one physical link)×80%=64 Mbps.

(4) Similarly, in case of the traffic amount of the object traffic 83a=50 Mbps, the discriminating portion 72 discriminates it to be “occupation releasing level” since the traffic amount=50 Mbps is equal to or less than 80 Mbps (traffic amount for one physical link)×80%=64 Mbps.

Steps S12 and S13: In case the “regular level” of (1) is discriminated at step S11, the discriminating portion 72 does not transmit a signal 91 to the number changing portion 75, but resets all of the counters (decreasing counter and releasing counter) with a signal 92. This resetting enables the count indicating how many times the traffic amount of the object traffic 83a has been continuously equal to or less than the threshold value to be returned to the initial value “0”. Thus, the number of the physical links is maintained.

Steps S14 and S15: In case the “number increasing level” of (2) is discriminated at step S11, the discriminating portion 72 notifies the f“number increasing level” to the number changing portion 75 with the signal 91, and then resets all of the counters with the signal 92. The number changing portion 75 provides a number increasing instruction signal 94 to the port manager 76.

The port manager 76 changes e.g. the port 10_3 in the table 77 to “∘: object traffic port” from “□: non-object traffic port”. Then, the port manager 76 provides, to the non-object assignment portion 25 (see FIG. 2), the update information 88 indicating that the physical link 80_11 (port 10_3) should be deleted and the number of the links should be decremented by “1”, and provides, to the object assignment portion 24 (see FIG. 2), the update information 87 indicating that the deleted physical link 80_11 should be added to the sub-logical link 82_3 and the number of the links should be incremented by “1”.

Steps S19. S20, and S13: In case the discriminating portion 72 discriminates the “number decreasing level” at step S11, the decreasing counter is incremented by “1” and the releasing counter is reset (at step S20). Furthermore, in case the value of the decreasing counter does not exceed the count set in the table 73=“50” (namely, in case the count indicating how many times the number decreasing level continuously occurs does not exceed “50”), the number of the physical links is maintained.

Steps S20, S21, and S15: In case the value of the decreasing counter exceeds the count=“50” (namely, in case the count indicating how many times the number decreasing level continuously occurs exceeds “50”), the number of the physical links is decremented by “1” in the same procedure as the above-mentioned procedure of incrementing the physical link by “11”, and then all of the counters are reset.

\mathring{3}: Release of Occupation Link

Steps S16, S17, and S13: In case the “occupation release level” is discriminated at step S11, the discriminating portion 72 provides the signal 92 for incrementing the releasing counter by “1” to the counter 74.

The counter 74 discriminates whether or not the value of the releasing counter exceeds the counter of the releasing counter=“50” in the table 73. Resultantly, in case the count does not exceed “50”, nothing is done. Namely, the number of the links is maintained.

Steps S17, S18, and S15: In case the value of the releasing counter exceeds the count of the releasing counter=“50” in the table 73, the counter 74 notifies the fact to the number changing portion 75 with a signal 93, so that the number changing portion 75 provides a number decreasing instruction signal 94 to the port manager 76.

The port manager 76 sets all of the ports 10 in the table 77 to “□: non-object traffic port”, and notifies that all of the ports are set to “□” to the object assignment portion 24 and the non-object assignment portion 25 respectively by the update information 87 and 88.

The object assignment portion 24 and the non-object assignment portion 25 respectively recognize that the occupation is released to distribute the object traffic 83a and the non-object traffic 83b to all of the ports 10. It is to be noted that the number decrease is discriminated by using a single decreasing counter, a single physical link is decreased, and by repeating this operation “n” physical links are decreased.

Furthermore, it is possible that the counter 74 is provided with a 1-decrementing counter, a 2-decrementing counter, . . . , and a “n”-decrementing counter. The discriminating portion 72 can discriminate whether or not the object traffic amount is in the level in which physical links 1, 2, . . . , “n” numbers may be decremented, and physical links “n” numbers can be decremented at a single discrimination by storing the discriminated continuous counter in the decreasing counters.

\mathring{4} Degeneracy of Non-occupation Link

Also, in case the degeneracy of the number of the physical links occurs by the fault in the sub-logical link established for a specified object traffic, the number is dynamically changed and returned to the original number. On the other hand, in case the fault occurs in the physical link for the non-object traffic, there is no physical link for the non-object traffic, so that the case where the non-object traffic can not be transmitted occurs.

Generally, when a link down state occurs, the number itself, in the port managing table 77, of the links aggregated by the link aggregation is decreased. The port manager 76 checks whether or not all of the ports 10 are occupied by the object traffic 83a in the table 77. If they are occupied, the fact is notified to the number changing portion 75.

The number changing portion 75 instructs the port manager 76 to decrease the number of the links in the port with the lowest priority. The priority of the port is supposed to be set in the apparatus.

The port manager 76 updates the port managing table 77 to notify the result to the object assignment portion 24 and the non-object assignment portion 25. Thus, the transmission disabling state of the non-object traffic 83b can be avoided.

It is to be noted that the collector 30 (see FIG. 14B) which receives the object traffic 83a and the non-object traffic 83b from the distributor 20 of the opposite band control device 100 may transmit the received object traffic 83a and the non-object traffic 83b to the MAC client 50 of the upper layer in the same way as the prior art collector 30.

Accordingly, if at least the apparatus on the transmitting side between two end apparatuses 1, between two end apparatus 1, and between the relaying apparatus 2 and the relaying apparatuses 2 is 20 provided with the band control device 100 according to the present invention, it is possible to increase/decrease the number of the physical links which the above-mentioned sub-logical link 82 exclusively used for the object traffic 83a aggregates or to release the occupation according to the traffic amount of the object traffic 83a.

As mentioned in the above \mathring{1}-\mathring{4}, by the embodiment (1), it is possible to assign one or more physical links to the traffic of the specified condition to guarantee the band, and to perform the band variable control of the traffic.

Embodiment (2)

In case the source end apparatus 1_1 transmits the object traffic 83_2 of the specified condition to the destination end apparatus 1_5 through the relaying apparatuses 2_1 and 2_2 in the network of FIG. 1D, for example, composed of the end apparatuses 1 and the relaying apparatuses 2 having the band control device 100 of the present invention, the sub-logical link which guarantees the band of the object traffic 83_2 must be established respectively between the source end apparatus 1_1—the relaying apparatus 2_1, the relaying apparatus 2_1—the relaying apparatus 2_2, and the relaying apparatus—the destination end apparatus 1_5.

The band control device 100 of the present invention in the source end apparatus 1_1 requests the network to establish the sub-logical link for the specified object traffic between the own device 100 to the band control device 100 of the destination end apparatus 1_5, thereby realizing the establishment of the sub-logical link.

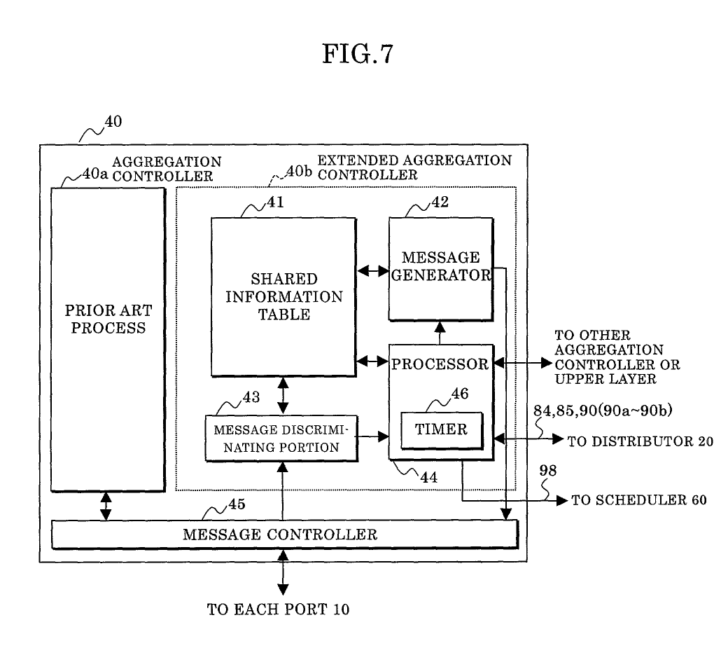

Hereinafter, the arrangement of the band control device 100 of the present invention in order to establish the sub-logical link in the network and the operation procedure will be described referring to FIGS. 7-10.

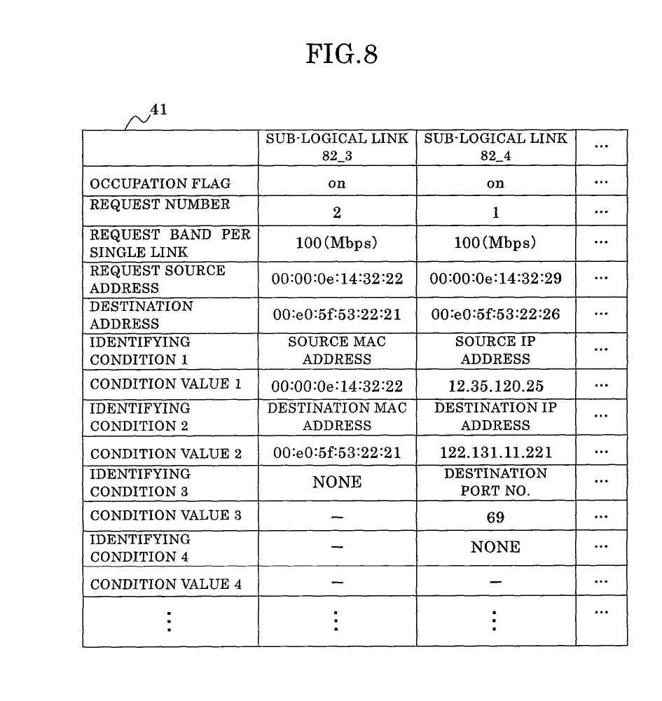

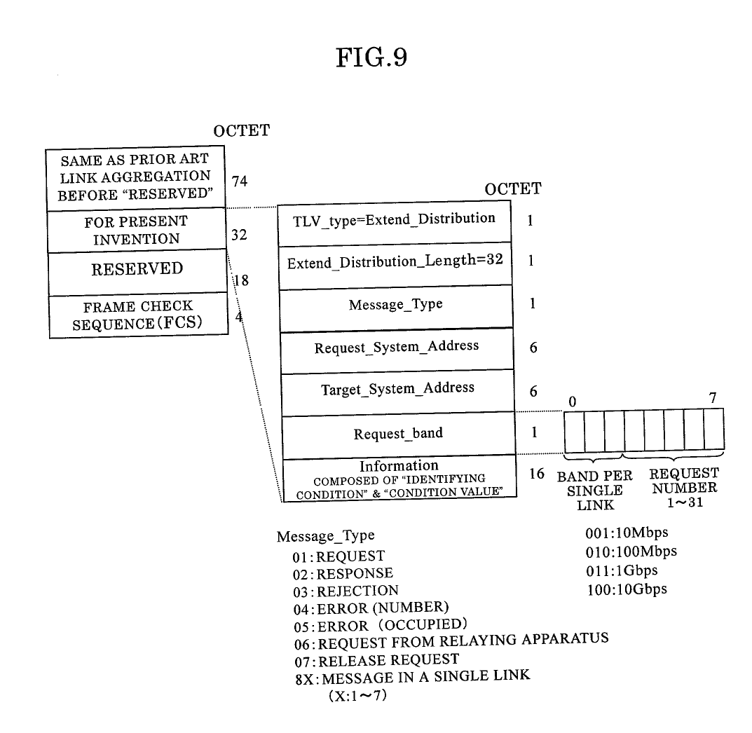

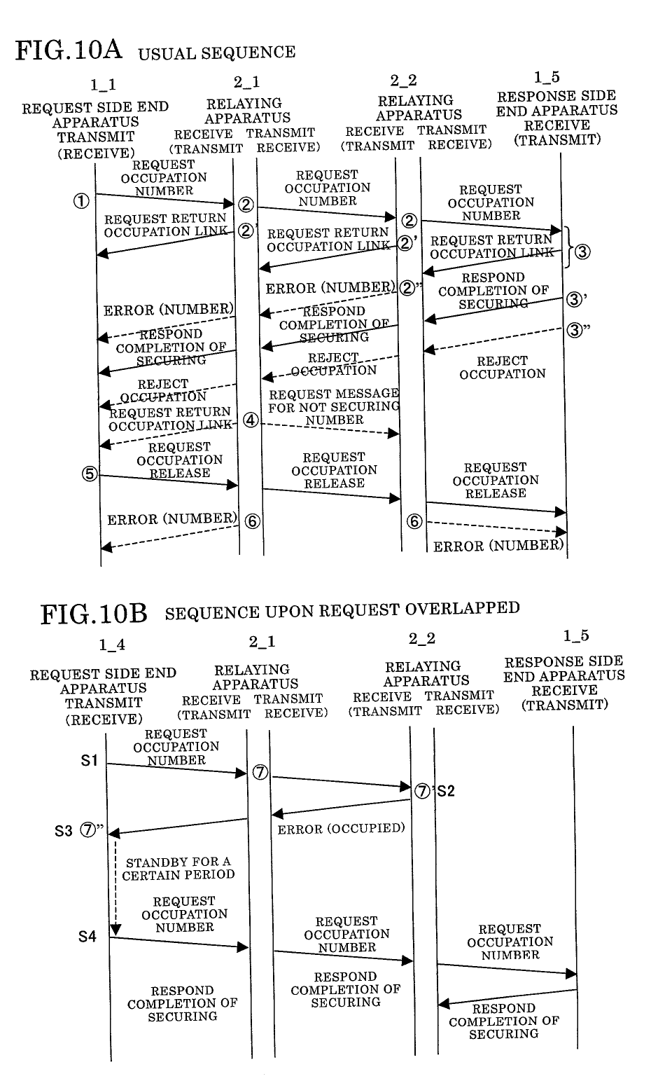

Hereinafter, the followings will be described: (1) schematic arrangement of an extended aggregation controller 40 of the band control device 100 according to the present invention shown in FIG. 7; (2) schematic arrangement of a shared information table 41 included in the controller 40 in FIG. 8; (3) arrangement of an extended LACPDU frame where the prior art LACPDU transmitted/received between the apparatuses is extended in FIG. 9; and (4) operation procedure in case where the source end apparatus 1_1 transmits the object traffic 83_2 of the specified condition to the destination end apparatus 1_5 through the relaying apparatuses 2_1 and 2_2 by referring to FIGS. 7-9 in the above (1)-(3) in FIG. 10.

FIG. 7 shows an embodiment of the aggregation controller 40 of the band control device 100 in the end apparatus 1 and the relaying apparatus 2 according to the present invention. In the arrangement of the aggregation controller 40, an extended aggregation controller 40b and a message controller 45 are added to the prior art controller 40a.

The controller 40b is composed of the shared information table 41, a message generator 42, a message discriminating portion 43, and a processor 44 which includes a timer 46.

FIG. 8 shows an arrangement of the shared information table 41, which is composed of “occupation flag”, “request number”, “request band (per single link)”, “request source address (transmitting source address)”, “destination address”, “identifying condition 1”, “condition value 1”, “identifying condition 2”, “condition value 2” . . . , “identification condition m”, and “condition value m” for each sub-logical link.

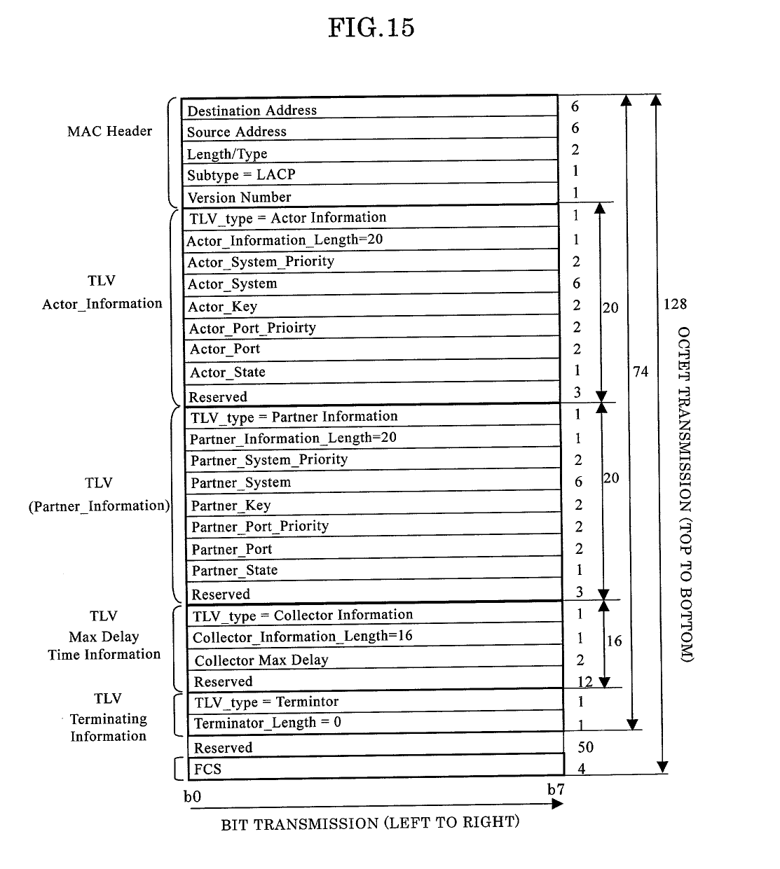

The establishment request of the sub-logical link in the source end apparatus is performed by the extended LACPDU frame in which the prior art LACPDU frame (see FIG. 15) is extended as shown in FIG. 9.

Namely, an extended message field of 32 octets is provided in a reserved field of 50 octets in the prior art frame. The extended message field is composed of 1-octet TLV type=“extended distribution”, 1-octet extended distribution length=“32”, 1-octet message type, 6-octet request system address, 6-octet target system address, 1-octet request band, and 16-octet information.

The TLV type and the extended distribution length indicate that the extended message is the extended distribution of 32 octets. As for the message type, the setting values “01”, “02”, “03”, “04”, “05”, “06”, “07”, and “8X” (X is 1-7) respectively indicate “request”, “response”, “rejection”, “error (number)”, “error (occupied)”, “request from relaying apparatus”, “release request”, and “message in a single link”.

The request system address and the target system address respectively indicate the addresses of the source apparatus and the destination apparatus.

Lower three bits of the request band indicate “band per single link”. The setting values “001”, “010”, “011”, and “100” respectively indicate “10 Mbps”, “100 Mbps”, “1 Gbps”, and “10 Gbps”. Upper five bits indicate the link request number of 1-31. The identifying information field is composed of “identifying condition (kind of identifying information)” and “condition value (value of identifying information)”.

FIGS. 10A and 10B show an operation procedure in case where the sub-logical link is established from the request source end apparatus 1_1 to the destination end apparatus 1_5 through the relaying apparatuses 2_1 and 2_2.

The arrangement and the connection relationship of the end apparatus 1_1, the relaying apparatuses 2_1, 2_2, and the end apparatus 1_5 are the same as those shown in FIG. 14A except the band control device 100 of the present invention is used as the band control device 100. It is to be noted that the port 10 and the physical links 80a and 80b indicate a plurality of ports 10 and physical links 80 in the same way as the arrangement shown in FIG. 14A.

\mathring{1}: Transmission of Occupation Request Message from end Apparatus 1_1 (see FIG. 10A\mathring{1})

The end apparatus 1_1 which desires to communicate by establishing the sub-logical link exclusively used for the traffic of the specified condition is supposed to be a request side-end apparatus, and the destination end apparatus 1_5 is supposed to be a response sideend apparatus.

In FIG. 10A, the request side-end apparatus 1_1 determines the “number (request number)” of the physical links which the apparatus desires to occupy by e.g. instructions from an upper layer application, the monitor of the traffic amount, or the like, so that the number is provided to the processor 44 of the controller 40b.

The processor 44 writes, in the shared information table 41, e.g. “own address (request source address)”=“000:00:0e:14:32:22”, “destination address”=“00:e0:5f:53:22:21”, “request number”=“2”, “band per single link”=“100 Mbps”, “identifying condition”, and “condition value” (“identifying condition 1”=“source MAC address”, “condition value 1”=“00:00:0e:14:32:22”, “identifying condition 2”=“destination MAC address”, and “condition value 2”=“00:e0:5f:53:22:21”, etc), and makes “occupation flag” on.

In addition, the processor 44 instructs the message generator 42 to generate the request message. The generator 42 prepares the extended message of the message type=“request” shown in FIG. 9 by referring to “request source address”, “destination address”, “request number”, “band per single link”, “identifying condition”, and “condition value” in the table 41, so that the extended message is transmitted to the message controller 45.

It is to be noted that the request system address and the target system address in FIG. 9 respectively correspond to the “request source address” and the “destination address”. The message controller 45 composes the LACPDU frame by the extended message and other information to be transmitted to the relaying apparatus 2_1 through any one of the ports 10 which transmits the message. It is to be noted that the transmitting ports 10 may be all of the ports occupied by the sub-logical link.

Also, the processor 44 writes, in the “kind of the identifying information” and the “value of the identifying information” of the identifying data table 22 (see FIGS. 2 and 3), “identifying condition” and “condition value” (“identifying condition 1” and “condition value 1”, “identifying condition 2” and “condition value 2”) respectively, and notifies the “request number” to the port manager 76.

The port manager 76 sets the occupation ports of the request number to “∘: object traffic port” in the port managing table 77 (see FIGS. 4 and 5C). The occupation ports are secured one after another based on the priority.

It is to be noted that the other data are not notified from the processor 44 but are set by the management tool (not shown).

It is also possible to use, for the “identifying condition” and the “condition value”, e.g. information such as an IP header or a TCP header besides the MAC address.

It is to be noted that if a bidirectional communication is supposed to be performed, the request side-end apparatus 10_1 does not yet commence the communication of the object traffic at this point since the link on one side from the request side-end apparatus 1_1 to the relaying apparatus 2_1 is occupied, and the communication is commenced when the response message is received from the response side-end apparatus 1_5.

\mathring{2}: Relay of occupation request message by relaying apparatus 2_1 (see FIG. 10A\mathring{2});

\mathring{2}′: Transmission of return occupation request message (see FIG. 10A\mathring{2}′); and

\mathring{2}″: Transmission of error (number error) message (see FIG. 10A\mathring{2}″)

Hereinafter, the operation in which the relaying apparatus 2_1 relays the occupation request message from the end apparatus 1_1 to the subsequent relaying apparatus 2_2 will be described.

In FIG. 10A\mathring{2}, the message controller 45 of the relaying apparatus 2_1 takes out the occupation request message of the extended portion from the received LACPDU frame to be transmitted to the message discriminating portion 43. The usual LACPDU frame portion is transmitted to the prior art aggregation controller 40a, so that the usual aggregation process is performed.

The discriminating portion 43 performs a primary process of the request message. Namely, the discriminating portion 43 confirms the “occupation flag” in the shared information table 41 (see FIG. 8), takes out the “source address”, the “destination address”, the “request band (band per single link, request number)”, and the “information (identifying condition and condition value)” in case of occupation flag=“off” to be written in the shared information table 41, so that the occupation flag is switched “on”. Also, the discriminating portion 43 transmits the message type=“request” to the processor 44.

It is to be noted that the process in case of the occupation flag=“on” will be described later referring to “\mathring{7} upon request from other end apparatus”.

Since the message type is “request”, the processor 44 notifies the “occupation request” to the subsequent apparatus.

Hereinafter, e.g. the processor 44 of the band control device 100a in the relaying apparatus 2_1 in the link aggregation group connected to the preceding apparatus (end apparatus 1_1) is referred to as the request side-processor 44, and the processor 44 of the band control device 100b in the link aggregation group connected to the subsequent apparatus (relaying apparatus 2_2) is referred to as the response side-processor 44, for convenience' sake.

While the “request side” and the “response side” are similarly attached to the table 41, the message generator 42, the message discriminating portion 43, and the message controller 45, they are occasionally omitted when they are self-evident.

The response side-processor 44 which has received the notification instructs the response side-message generator 42 to generate the request message. In case of [\mathring{1}: occupation request from the end apparatus 1_1], the generator 42 generates the request message by the same process to be transmitted to the message controller 45. The controller 45 transmits the request message to the subsequent relaying apparatus 2_2 from the port 10 which forms the object.

Also, the processor 44 writes the same information as in case of [\mathring{1}: occupation request from the end apparatus 1_1] in the identifying data table 22 of the response side-distributor 20 and the port managing table 77 included in the manager 23. It means that the communication between the request side and the response side-end apparatuses has been set to be performed by the occupied sub-logical link.

The request side-processor 44 simultaneously performs the process for securing the return sub-logical link. Namely, in FIG. 10A\mathring{2}′, the processor 44 notifies port information 90c for “request number” with a high priority to the port manager 23 based on the “request number” and the priority of the port included in the request message.

It is to be noted that as for the priority of the port used at this time, the port with a higher priority set to each apparatus is used so that the same port may be selected between the opposite apparatuses. The port priority information is stored as the internal data of the apparatus.

Also, the request side-processor 44 notifies the identifying information 84 to the identifying data table 22 (see FIG. 2) for identifying the traffic 83a which forms the object. In case the request side-address and the response side-address of the MAC address, the IP address, or the like are used, the return link from the response side to the request side must be occupied. Therefore, the identifying information 84 at this time makes the traffic, an object traffic, in which the response side-address and the request side-address are respectively made a source address and a destination address.

Thus, the same sub-logical link can be occupied at the time of outgoing (object traffic from the request side to the response side) and returning (object traffic from the response side to the request side).

Generally in the relaying apparatus of the network, there are some cases where the band for a single physical link and the number of the links aggregated are different depending on the link aggregation group (logical link). Therefore, it is assumed that there are sections which have a band less than a required band in some relaying apparatus between two end apparatuses.

In this case, there is a possibility that the following problems arise: (1) Since the section is occupied by the object traffic, other communication can not be performed; (2) In the communication between two end apparatuses, the section becomes a bottleneck.

In order to solve the problems, in FIG. 10A\mathring{2}″, the request side-processor 44 compares the band of the link aggregation group connected to the subsequent apparatus with the request band by referring to the shared information table 41 (see FIG. 8). Since at least one physical link which is not occupied is required for the other communication, the process for decreasing the occupation number is performed in case the condition of “group band”>“request band” is not satisfied.

Namely, the request side-processor 44 instructs the message generator 42 to decrease the value of the “request number” in the shared information table 41 to generate an error (number) message. The message generator 42 transmits the generated message to the message controller 45.

The message controller 45 transmits the error (number) message from the port with the lowest priority for the request side to the request source side-end apparatus 1_1. The port which has received the message is excluded from the object of the occupation.

The relaying apparatus or the end apparatus which has received the error (number) message releases the secured link. The relaying apparatus further relays the message to the request side, so that by repeating the relay, the message is transmitted to the end apparatus.

\mathring{3}:Securing return occupation link by response side-end apparatus 1₁₃ 5 (see FIG. 10A\mathring{3})

\mathring{3}′:Sending back response message of link securing completion (see FIG. 10A\mathring{3}′); and

\mathring{3}″:Sending back rejection message

In FIG. 10A\mathring{3}, the discriminating portion 43 of the end apparatus 1_5 performs a primary process of the request message received through the message controller 45 (see [\mathring{2}: relay of the occupation request message by relaying apparatus 2_1]. Furthermore, the discriminating portion 43 transmits the message type=“request” to the processor 44.

The processor 44 secures the ports of the request numbers sequentially from the port with higher priority based on the port information stored as the internal data and the request message, so that the port is notified to the port manager 76 (see FIG. 4). The port manager 76 sets the port in the port managing table 77 to secure the sub-logical link of the object traffic 83.

Furthermore, the processor 44 notifies the identifying information (identifying condition and condition value, see FIGS. 8 and 9) of the request message to the identifying data table 22 (see FIGS. 2 and 3). In the same way as the case of [\mathring{2}′: transmission of the return occupation request message in the relaying apparatus], the traffic is established where the request side address is made a destination address and the response side address is made a transmitting source address. Thus, the return sub-logical link is secured.

In addition, the processor 44 instructs the message generator 42 to generate the message in FIG. 10A\mathring{3}′. The message generator 42 transmits the response message to the request side-end apparatus 1_1 through the message controller 45 by using the return link.

Although the number of links according to the occupation request can be secured at the present time, there are some cases where the response side-end apparatus 1_2 does not desire to secure the occupation link for the end apparatus 1_1 for some reason such as the case where priority is given to the occupation from another end apparatus.

In order to attend to this case, the end apparatus 1_2 can return the response message (see FIG. 9) in which the request number is decreased, so that a part of the request number can be rejected.

Furthermore, in case the end apparatus 1_2 can not respond to all of the request number in FIG. 10A\mathring{3}″, it can return the rejection message to the request side-end apparatus 1_1. In this case, the occupation can not be performed.

\mathring{4}: Support for a Single Link with a Large Bandwidth

As the interval between the relaying apparatuses 2_1 and 2_2 shown in FIG. 1B, there is a possibility that some parts have only a single physical link 80 of a large band without considering the redundancy in the arrangement of the system. The process in such a case will be described based on the arrangement of FIG. 1B.

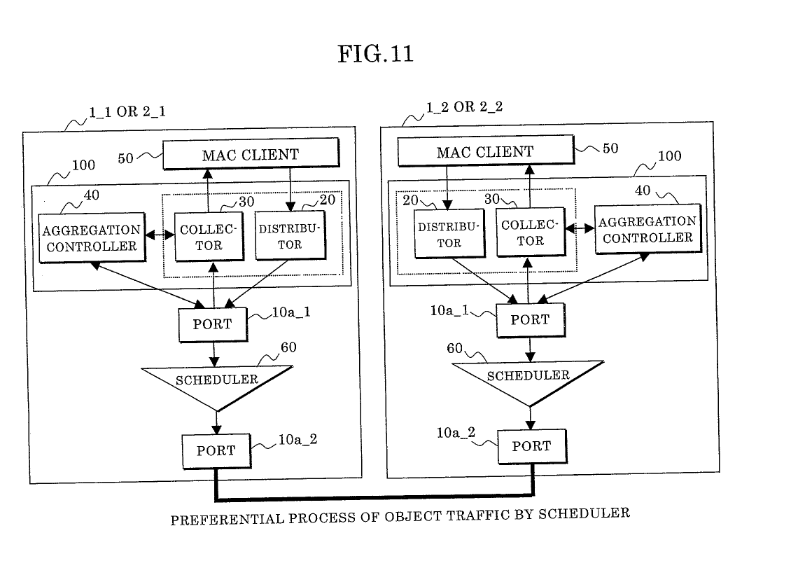

FIG. 11 shows a network in which the end apparatus 1 and the relaying apparatus 2 are connected with a single physical link 80. It is supposed that a port 10a_1 connected to the band control device 100 of the present invention is connected to the physical link through a scheduler 60 and a port 10a_2 in the relaying apparatuses 2_1 and 2_2 in FIG. 1B. It is to be noted that the scheduler 60 is included in the band control device 100.

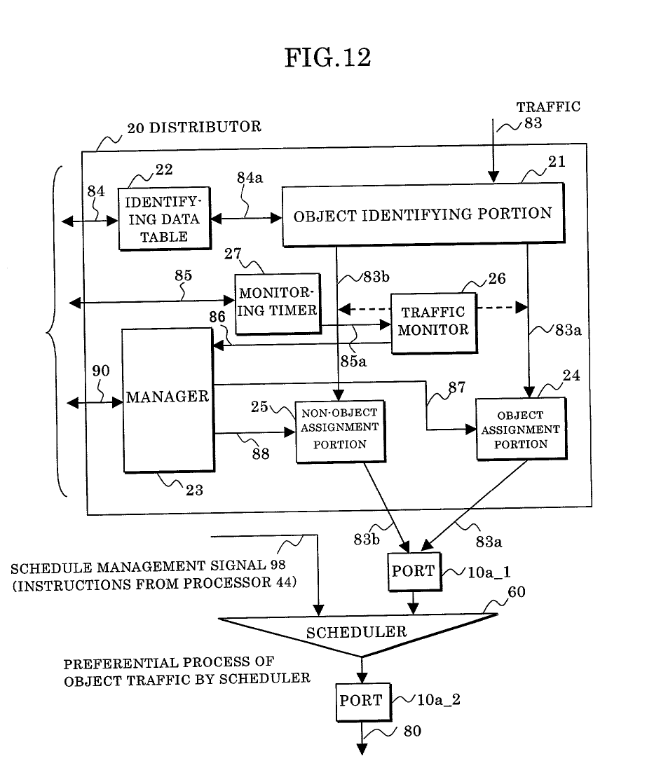

FIG. 12 shows a connection between the distributor 20 and the scheduler 60 shown in FIG. 11 more in detail. The object assignment portion 24 and the non-object assignment portion 25 respectively transmit the object traffic 83a and the non-object traffic 83b to the port 10a_1.

The port 10a_1 provides the received traffics 83a and 83b to the scheduler 60. The scheduler 60 transmits the traffics 83a and 83b to the port 10a_2 connected to the physical link 80 based on a schedule management signal 98 from the processor 44 (see FIG. 7).

In FIG. 10A\mathring{4}, the relaying apparatus 2_1 receives the request message from the end apparatus 1_1, and secures the return link in the same way as the case [\mathring{2} : Relay of occupation request message by relaying apparatus 2_1].

The response side-processor 44 of the relaying apparatus 2_1 instructs the message generator 42 to generate the request message which does not secure the number, since there is only one physical link 80 to the subsequent relaying apparatus 2_2. The message generator 42 transmits the generated request message to the relaying apparatus 2_2.

At this time, the processor 44 instructs the scheduler 60 to preferentially process the object traffic which meets the specified condition by the schedule managing signal 98. The scheduler 60 preferentially transmits the object traffic within the traffic, and processes the non-object traffic in the same way as the usual case.

While the relaying apparatus 2_2 which has received the request message not securing the number does not occupy the return link, the request side-processor 44 notifies the scheduler 60 to preferentially process the object traffic in the same way as the relaying apparatus 2_1.

It is to be noted that in case of using a route with a single physical link, a message type is temporarily changed. Namely, the upper 4 bits of the message type in FIG. 9 are changed to “1000=8”, while the lower four bits are not changed.

The apparatus which has received the message discriminates the message of a single link by the upper 4 bits, and can recognize the message type by the lower 4 bits. When relaying the message, the relaying apparatus returns the upper bits to “0000” so that the former message type is restored to be transmitted to the subsequent apparatus.

\mathring{5}: Release of Occupied Link (see FIG. 10A\mathring{5})

When the object traffic communication is completed, it is necessary to release the occupation link and to avoid the state where the band is uselessly occupied.

When having completed the transmission of the object traffic using the occupied sub-logical link in the request side-end apparatus 1_1, for example, the upper layer notifies that the transmission is completed to the processor 44 (see FIG. 7).

The processor 44 instructs the message generator 42 to generate the link release request message. The message generator 42 generates the release request message in which the message type is made “release request” (see FIG. 9) to be transmitted from the occupied ports 10, so that the occupation of the ports is released.

Specifically, the processor 44 makes the occupation flag of the shared information table 41 (see FIGS. 7 and 8) “off”, and all of the ports of the port managing table (see FIGS. 4 and 5C) “□” indicating the non-occupation state.

In the relaying apparatus 2_1 having received the release request message, the request side-processor 44 confirms the message type=“release request”, and releases the occupation link in the same way as the above. In addition, the request side-processor 44 notifies the response side-processor 44 that there is a release request in order to transmit the release request message to the subsequent relaying apparatus 2_2.

The response side-processor 44 proceeds the generation of the release request message in order to relay the release request message to the relaying apparatus 2_2, and releases the occupation port on the response side.

In case no release request message is transmitted nor relayed for some reason in the above-mentioned procedure, an unnecessary sub-logical link is not released. Therefore, in the relaying apparatuses 2_1 and 2_2, and the response side-end apparatus 1_2, the traffic monitor 26 (see FIG. 2) monitors the object traffic to provide the traffic amount information 86 to the discriminating portion 72 (see FIG. 4) of the manager 23.

The discriminating portion 72 instructs the processor 44 to release the occupation in the absence of object traffic for a fixed period based on the traffic amount information 86. The processor 44 releases the occupation state.

\mathring{6}: Decreasing Operation of Occupation Number (see FIG. 10A\mathring{6})

(1) If the physical link is disconnected due to a failure, or (2) if the non-object traffic increases, there are some cases where the number of the physical links of the object traffic must be decreased. Hereinafter, the process in case where the physical link 80 is disconnected between the relaying apparatuses 2_1 and 2_2 in the arrangement of FIG. 1D and the non-object traffic increases will be described.

(1.1) In Case Disconnected Physical Link is Occupation Link

In case the physical link 80_10 included in the sub-logical link 82_3 is disconnected for example, the processor 44 (see FIG. 7) checks whether or not the substitution link exists in the relaying apparatuses 2_1 and 2_2 which have detected the disconnection in the same process as the case of the usual occupation.

In the presence of the substitution link, the processor 44 performs a process of substituting the link for the disconnected link, i.e. a changing process of the port managing table 77 (see FIGS. 4 and 5C).

In the absence of the substituting link, the processor 44 decreases the value of the “request number” in the shared information table 41 (see FIGS. 7 and 8) by one. In addition, the processor 44 instructs the message generator 42 to prepare the error (number) message (see FIG. 9) for decreasing the number, and to transmit the message to the apparatus (end apparatus 1_1 in case of relaying apparatus 2_1, and end apparatus 1_2 in case of relaying apparatus 2_2) opposite to the side where the disconnection of the message is detected.

The end apparatuses 1_1 and 1_2 which have received the error (number) message perform the process for releasing the occupation of the link with the lowest priority. This process is the same as the usual request of the occupation number, and releases the occupation of the link instead of securing the link of the occupation number.

(1.2) In Case Disconnected Physical Link is Non-occupation Link

In case the physical link 80_12 is disconnected for example, the port manager 76 (see FIG. 4) checks whether or not there are any non-occupation link except the disconnected link, by referring to the port managing table 77, in the relaying apparatuses 2_1 and 2_2 which have detected the disconnection, and instructs the processor 44 to decrease the number of the occupation link in the absence of the other non-occupation links. The process hereafter is the same as (1.1) “the case of no substituting link”. Thus, the number of the occupation link is decreased.

(2) In Case Non-object Traffic Increases

The traffic monitor 26 (see FIG. 2) of each apparatus monitors the non-object traffic 83b. In case it is discriminated that the traffic amount has exceeded the port available rate for the non-object traffic set in the threshold value table 71 (see FIG. 5), the discriminating portion 72 (see FIG. 4) confirms the traffic amount of the object traffic 83a, and confirms whether or not the occupation link number can be decreased from the available rate.

In case the link number can be decreased, the port manager 76 (see FIG. 4) instructs the processor 44 (see FIG. 7) to decrease the number. The process hereafter is the same as the cases (1.1) and (1.2) except that the message is transmitted to both of the request side-end apparatus 1_1 and the response side-end apparatus 1_2.

\mathring{7}: Upon Request from Other end Apparatus (see FIG. 10B\mathring{7})

In the present invention, it is possible to establish a plurality of sub-logical links in a single logical link (link aggregation group). Hereinafter, the process performed in case the occupation request is transmitted from another end apparatus on the route occupied between certain end apparatuses will be described referring to FIG. 10B.

(1) In Case of Newly Requested Route Being Securable

The route can be secured by the same signaling as the usual method. However, in case the route has been already occupied by the request between the other end apparatuses (in case of the occupation flag of the shared information table 41 of FIGS. 7 and 8=“on”), the sub-logical link condition for the subsequent group is stored in the shared information table 41.

For example, in case the object traffic 83_2 desires to occupy the interval between the end apparatuses 1_4 and 1_8 when the object traffic 83_1 occupies the interval between the end apparatuses 1_1 and 1_5 by the sub-logical links 82_1, 82_3, and 82_5 in FIG. 1D, the interval between the relaying apparatuses 2_1 and 2_2 has already been occupied by the sub-logical link 82_3.

Therefore, the information of another sub-logical link 82_4 for the interval between the end apparatuses 1_4 and 1_8 is held in the shared information table 41 (see FIG. 8), so that both of the sub-logical links 82_3 and 82_4 are set in the identifying data table 22 of the relaying apparatuses 2_1 and 2_2 as shown in FIG. 3C.

Also, in case only a port of the requested occupation number can be occupied, the same process as the usual sequence shown in FIG. 10A is performed, so that the number which can be occupied is secured.

(2) In Case of Newly Requested Route Not Being Securable (see FIG. 10B\mathring{7}′)

The error (occupied) message (see FIG. 9) indicating that the route can not be secured is returned. Namely, in FIG. 7, the processor 44 confirms that the occupation flag of the sub-logical link 82_3=“on” in the shared information table 41 (see FIG. 8), and instructs the message generator 42 to generate the error (occupied) message in case the requested band can not be secured.

The generator 42 sends back the generated message to the request source side-end apparatus 1_1 (see FIG. 10B\mathring{7}′). The end apparatus 1_1 which has received the message stands by for a fixed time, and then again requests the occupation (see FIG. 10B\mathring{7}″).

Hereinafter, the process sequence in case where an object traffic (not shown) desires to occupy the interval between the end apparatuses 1_4 and 1_5 when the object traffic 83_1 occupies the interval between the end apparatuses 1_1 and 1_5 by the sub-logical links 82_1, 82_3, and 82_5 will be described referring to FIG. 10B.

Firstly, the request message of the occupation number is transmitted to the relaying apparatus 2_2 from the end apparatus 1_4 through the relaying apparatus 2_1 (at step S1). Since the relaying apparatus 2_2 can not establish the sub-logical link in the logical link between its own apparatus and the response side-end apparatuses 1_5, the error (occupied) message is sent back to the request side-end apparatus 1_4 (at step S2).

The end apparatus 1_4 which has received the message stands by for a fixed time based on the timer 46 (see FIG. 7) of the processor 44 (at step S3), and then performs the resending process (at step S4). The sequence hereafter is the same as the usual sequence.

\mathring{8}: Decreasing Operation of Occupation Number upon a Plurality of Sub-logical Links Established

In case the occupation number of the physical links within the logical link 81_3 is decreased by a failure or the like in FIG. 1D, the relaying apparatuses 2_1 and 2_2 where a plurality of sub-logical links 82_3 and 82_4 are established in a single logical link 81_3 decrease the occupation number in the sub-logical link with a lower priority determined based on the available rate.

The processor 44 (see FIG. 7) compares the available rates (priorities) of sub-logical links at the time of decreasing the number. As a result, the number in the sub-logical link with the lowest priority is decreased in the same procedure as [\mathring{6}: decreasing operation of occupation number].

As described above, a band control device according to the present invention is arranged such that a distributor distributes a traffic to a sub-logical link into which specified ones of the physical links in the logical link are aggregated so as to meet a specified condition of the traffic. Therefore, it becomes possible to guarantee the band of the traffic.

Also, the band control device according to the present invention is arranged such that the physical links of a number corresponding to the traffic amount are assigned to the sub-logical link. Therefore, it becomes possible to perform a band variable control according to the traffic amount.

Furthermore, the band control device according to the present invention is arranged such that a message for establishing the sub-logical link is transmitted/received to/from an opposite controller, and the message is relayed to the subsequent apparatus. Therefore, it becomes possible to perform a trunking of establishing the sub-logical link in the network.

As a result, the network has a redundant arrangement by the trunking function and more secure network can be provided to the communication or the like of the basic business.

Also, in case Ethernet which enables a long distance transmission is used as a network, a band guarantee and a redundancy can be provided to the communication between bases of an intranet or the like by applying the band control device of the present invention to WAN (Wide Area Network) and MAN (Metro Area Network).

What we claim is:

1. A band control device comprising:
a controller for aggregating a plurality of physical links into a single logical link, and
a distributor for distributing a traffic to a sub-logical link into which specified ones of the physical links in the logical link are aggregated so as to meet a specified condition of the traffic.

2. The band control device as claimed in claim 1 wherein the distributor comprises a traffic monitor for monitoring a traffic amount which meets the specified condition, and a manager for assigning the physical links of a number corresponding to the traffic amount to the sub-logical link.

3. The band control device as claimed in claim 2 wherein when detecting that the traffic amount becomes smaller than a predetermined value during a predetermined period, the traffic monitor releases an aggregation of the sub-logical link to assign no sub-logical link exclusively used for the traffic which meets the specified condition.

4. The band control device as claimed in claim 1 wherein the controller transmits/receives a message for establishing the sub-logical link to/from an opposite controller.

5. The band control device as claimed in claim 4 wherein the controller relays the message to a subsequent apparatus.

6. The band control device as claimed in claim 1 wherein a number of physical links which the distributor aggregates into the sub-logical link is smaller than the number of physical links which the logical link aggregates.

7. The band control device as claimed in claim 4 wherein the controller returns a message for establishing a sub-logical link port established based on the received message as a return sub-logical link port.

8. The band control device as claimed in claim 4 wherein the controller returns a response message for the received message.

9. The band control device as claimed in claim 4 wherein the controller returns, in response to the message requesting the establishment of the sub-logical link, a message rejecting the request.

10. The band control device as claimed in claim 8 wherein when receiving the response message, the controller commences a communication of the traffic which meets the specified condition.

11. The band control device as claimed in claim 5 wherein when a band of the sub-logical link requested by the received message is larger than an assignable band of a sub-logical link in the subsequent apparatus, the controller discards the message and returns an error message.

12. The band control device as claimed in claim 5, further comprising a scheduler for transmitting a traffic, with a priority control, to the subsequent apparatus, the controller instructing the scheduler to transmit the traffic which meets the specified condition with a priority, and transmitting a message notifying a request band of the traffic to the subsequent apparatus.

13. The band control device as claimed in claim 4 wherein when a communication of the traffic which meets the specified condition is completed, the controller transmits a message requesting an establishment release of the sub-logical link corresponding to the traffic.

14. The band control device as claimed in claim 13 wherein when receiving the message requesting the establishment release, the controller relays the establishment release request message to a subsequent apparatus.

15. The band control device as claimed in claim 4, further comprising a traffic monitor for monitoring a traffic amount which meets the specified condition,
the controller releasing the establishment of the sub-logical link when the traffic amount becomes smaller than a predetermined amount.

16. The band control device as claimed in claim 4 wherein when the physical link included in the sub-logical link degenerates and no physical link substituted for the degenerated physical link can be secured, the controller transmits a message requesting that a number of physical links included in the sub-logical link should be decreased.

17. The band control device as claimed in claim 4 wherein when no physical link exists since the physical link excluded in the sub-logical link is degenerated, the controller transmits a message requesting that a number of physical links included in the sub-logical link should be decreased.

18. The band control device as claimed in claim 4, further comprising a traffic monitor for monitoring an amount of a traffic except the traffic which meets the specified condition,
the controller decreasing a number of physical links included in the sub-logical link when the traffic amount becomes larger than a predetermined amount, and outputting a message requesting that the number should be decreased.

19. The band control device as claimed in claim 16, 17, or 18 wherein when receiving the number decrease request message, the controller decreases the number of physical links included in a corresponding sub-logical link.

20. The band control device as claimed in claim 19 wherein the controller further relays the number decrease request message to a subsequent apparatus.

21. The band control device as claimed in claim 4 wherein when receiving a message requesting an establishment of a sub-logical link different from the sub-logical link already established and no requested band can be secured, the controller returns an error message.

22. The band control device as claimed in claim 21 wherein when receiving the error message, a source controller of the establishment request message transmits again the establishment request message after a standby for a fixed period.

23. The band control device as claimed in claim 4 wherein when a plurality of sub-logical links are established in the single logical link, the controller determines a sub-logical link for decreasing a number of physical links by a priority of the sub-logical link.

24. The band control device as claimed in claim 1, further comprising a collector for receiving the traffic from an opposite apparatus.
